(19) United States
(12) Patent Application Publication
(10) Pub. No.: US 2015/0261140 A1
(43) Pub. Date: Sep. 17, 2015

(54) TRANSFER DEVICE AND IMAGE FORMING APPARATUS INCLUDING SAME

(71) Applicants: Katsuaki Miyawaki, Kanagawa (JP); Tetsuo Watanabe, Kanagawa (JP); Hiromichi Matsuda, Kanagawa (JP); Kimiharu Yamazaki, Kanagawa (JP)

(72) Inventors: Katsuaki Miyawaki, Kanagawa (JP); Tetsuo Watanabe, Kanagawa (JP); Hiromichi Matsuda, Kanagawa (JP); Kimiharu Yamazaki, Kanagawa (JP)

(73) Assignee: Ricoh Company, Ltd., Tokyo (JP)

(21) Appl. No.: 14/642,001

(22) Filed: Mar. 9, 2015

(30) Foreign Application Priority Data
Mar. 12, 2014 (JP) 2014048951

(51) Int. Cl. G03G 15/16

(52) U.S. Cl. CPC G03G 15/1605

(57) ABSTRACT

A transfer device includes at least one pair of lateral plates, an intermediate transfer belt, a plurality of rollers, and a dynamic vibration absorber. The intermediate transfer belt is formed into an endless loop and is entrained about the plurality of rollers. The dynamic vibration absorber is disposed on at least one of the plurality of rollers and includes an inertial body. The inertial body is disposed inside the endless loop of the intermediate transfer belt, and both ends of the inertial body in an axial direction of the inertial body are rotatably supported by the at least one pair of lateral plates via shaft bearings.

### CROSS-REFERENCE TO RELATED APPLICATIONS

This patent application is based on and claims priority pursuant to 35 U.S.C. §119 to Japanese Patent Application No. 2014-048951, filed on Mar. 12, 2014, in the Japan Patent Office, the entire disclosure of which is hereby incorporated by reference herein.

### BACKGROUND

1. Technical Field

Exemplary aspects of the present disclosure generally relate to an electrophotographic transfer device including an intermediate transfer belt and an image forming apparatus including the transfer device, more particularly to a transfer device capable of reducing shock jitter when receiving a recording medium.

2. Description of the Related Art

In known electrophotographic image forming apparatuses, an image formed on a photoconductor is transferred primarily onto a transfer medium (hereinafter referred to as an intermediate transfer belt) at a primary transfer position in a process known as primary transfer, and then the image is transferred onto a recording medium in a process known as secondary transfer. This imaging process is generally employed in a tandem-type color image forming apparatus.

In the secondary transfer, when a recording medium enters a secondary transfer position at the beginning of secondary transfer, the traveling speed of the intermediate transfer belt changes, causing transfer failure at the primary transfer position during the primary transfer, in particular, producing a blurred image. This fluctuation in the traveling speed of the intermediate transfer belt is referred to as shock jitter.

In the secondary transfer, a secondary transfer roller is pressed against an opposed roller via the intermediate transfer belt at the secondary transfer position. Thus, when the recording medium enters the secondary transfer position between the secondary transfer roller and the opposed roller, hence generating impact, the impact is transmitted downstream in the traveling direction of the intermediate transfer belt. As a result, the image at the primary transfer position, at which the intermediate transfer belt contacts the photoconductor, gets disturbed during the primary transfer. Furthermore, when the photoconductor is shaken, an exposure position is changed undesirably.

### SUMMARY

In view of the foregoing, in an aspect of this disclosure, there is provided a novel transfer device including at least one pair of lateral plates, an intermediate transfer belt, a plurality of rollers, and a dynamic vibration absorber. The intermediate transfer belt is formed into an endless loop. The intermediate transfer belt is entrained about the plurality of rollers. The dynamic vibration absorber is disposed on at least one of the plurality of rollers and includes an inertial body. The inertial body is disposed inside the endless loop of the intermediate transfer belt, and both ends of the inertial body in an axial direction of the inertial body are rotatably supported by the at least one pair of lateral plates via shaft bearings.

According to another aspect, an image forming apparatus includes the transfer device.

The aforementioned and other aspects, features and advantages would be more fully apparent from the following detailed description of illustrative embodiments, the accompanying drawings and the associated claims.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a schematic diagram illustrating a color printer as an example of an image forming apparatus using a tandem-type indirect transfer method according to an illustrative embodiment of the present disclosure;

FIG. 2 is a perspective view schematically illustrating a transfer device including a dynamic vibration absorber employed in the image forming apparatus of FIG. 1;

FIG. 3 is a top view schematically illustrating the dynamic vibration absorber of FIG. 2 according to an illustrative embodiment of the present disclosure;

FIG. 4 is a perspective view schematically illustrating the dynamic vibration absorber of FIG. 2 according to an illustrative embodiment of the present disclosure;

FIG. 5 is an enlarged perspective view schematically illustrating the dynamic vibration absorber of FIG. 2 according to an illustrative embodiment of the present disclosure;

FIG. 6 is an enlarged cross-sectional view schematically illustrating the dynamic vibration absorber of FIG. 2 according to an illustrative embodiment of the present disclosure;

FIG. 7 is a graph showing frequency response characteristics from a belt drive motor to a driven roller of an illustrative embodiment of the present disclosure, compared with a related-art configuration;

FIG. 8 is a waveform chart showing measured fluctuation of traveling speed of an intermediate transfer belt before and after a recording medium enters a secondary transfer nip in a case in which the dynamic vibration absorber is not attached to the driven roller; and

FIG. 9 is a waveform chart showing measured fluctuation of traveling speed of the intermediate transfer belt before and after the recording medium enters the secondary transfer nip in a case in which the dynamic vibration absorber is attached to the driven roller.

### DETAILED DESCRIPTION

A description is now given of illustrative embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of this disclosure.

In addition, it should be noted that the terminology used herein is for the purpose of describing particular embodiments only and is not intended to be limiting of this disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In a later-described comparative example, illustrative embodiment, and alternative example, for the sake of simplicity, the same reference numerals will be given to constituent elements such as parts and materials having the same functions, and redundant descriptions thereof omitted.

Typically, but not necessarily, paper is the medium from which is made a sheet on which an image is to be formed. It should be noted, however, that other printable media are available in sheet form, and accordingly their use here is included. Thus, solely for simplicity, although this Detailed Description section refers to paper, sheets thereof, paper feeder, etc., it should be understood that the sheets, etc., are not limited only to paper, but include other printable media as well.

In order to facilitate an understanding of the novel features of the present disclosure, as a comparison, a description is provided of a comparative example of an image forming apparatus.

In the comparative example of an electrophotographic image forming apparatus, an image formed on a photoconductor is transferred primarily onto a transfer medium (hereinafter referred to as an intermediate transfer belt) at a primary transfer position in a process known as primary transfer, and then the image is transferred onto a recording medium in a process known as secondary transfer. This imaging process is generally employed in a tandem-type color image forming apparatus.

In the secondary transfer, when the recording medium enters a secondary transfer position at the beginning of secondary transfer, the traveling speed of the intermediate transfer belt changes, causing transfer failure at the primary transfer position during the primary transfer, in particular, producing a blurred image. This fluctuation in the traveling speed of the intermediate transfer belt is referred to as shock jitter.

In the secondary transfer, a secondary transfer roller is pressed against an opposed roller via the intermediate transfer belt at the secondary transfer position. Thus, when the recording medium enters the secondary transfer position between the secondary transfer roller and the opposed roller, generating impact, the impact is transmitted downstream in the traveling direction of the intermediate transfer belt. As a result, the image at the primary transfer position, at which the intermediate transfer belt contacts the photoconductor, gets disturbed during the primary transfer. Furthermore, the photoconductor is shaken, hence changing an exposure position.

In view of the above, a flywheel having a relatively large moment of inertia is attached to support rollers, about which the intermediate transfer belt is entrained. In this configuration, the moment of inertia of the flywheel prevents the impact generated upon entry of the recording medium into the secondary transfer position from getting transmitted to the primary transfer position.

However, in order to suppress shock jitter or fluctuation of traveling speed of the intermediate transfer belt using the flywheel, a significant level of moment of inertia is required of the flywheel. Thus, the flywheel tends to have a large diameter, and it is difficult to accommodate the flywheel inside a lateral plate of an intermediate transfer belt unit. Instead, a space between lateral plates of a main body of the image forming apparatus is increased to accommodate the flywheel. As a result, the size of the image forming apparatus is increased, thereby complicating efforts to make the image forming apparatus as a whole as compact as is usually desired. Furthermore, a greater output is required of a motor as a drive source, hence increasing the cost.

In view of the above, there is demand for an image forming apparatus capable of reducing the shock jitter in the intermediate transfer belt upon entry of the recording medium into the secondary transfer position, thereby preventing imaging failure while reducing the size and the cost of the image forming apparatus.

The present inventors have recognized a speed fluctuation (shock jitter) mechanism of an intermediate transfer belt caused by entry of a recording medium into a secondary transfer nip between a secondary transfer roller and an opposed roller.

More specifically, when the recording medium enters the secondary transfer nip at which the secondary transfer roller and the opposed roller meet and press against each other, a pressure increases, causing a load torque associated with the pressure to act on an intermediate transfer belt. As a result, the traveling speed of the intermediate transfer belt fluctuates. The traveling speed fluctuates at a certain frequency and attenuates. The present inventors have also recognized that when frequency response characteristics from a motor as a drive source of the intermediate transfer belt to a driven roller are measured, a resonance frequency and the frequency of fluctuation of the traveling speed of the intermediate transfer belt when the recording medium enters the secondary transfer nip coincide with each other.

Furthermore, the present inventors have recognized that reducing a gain at a resonance point of the frequency response characteristics between the motor and the driven roller can reduce fluctuation of the traveling speed of the intermediate transfer belt. According to an experiment performed by the present inventors, when a dynamic vibration absorber is employed to reduce a resonance gain, fluctuation of the traveling speed of the intermediate transfer belt is reduced or suppressed.

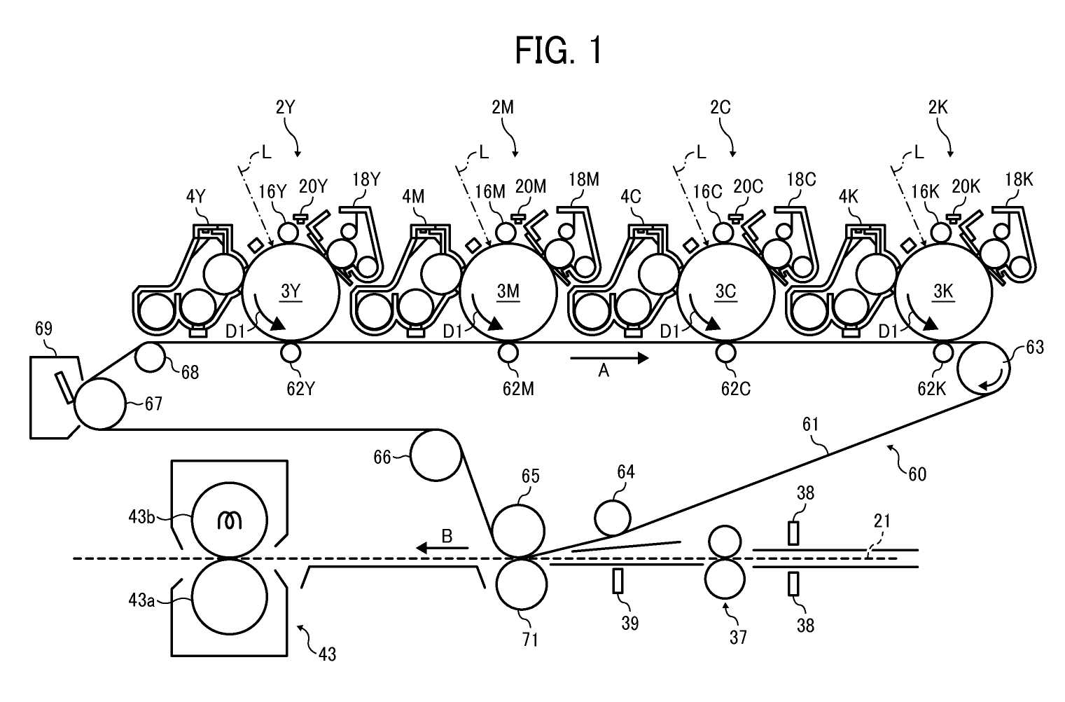

With reference to FIG. 1, a description is provided of an image forming apparatus according to an illustrative embodiment of the present disclosure.

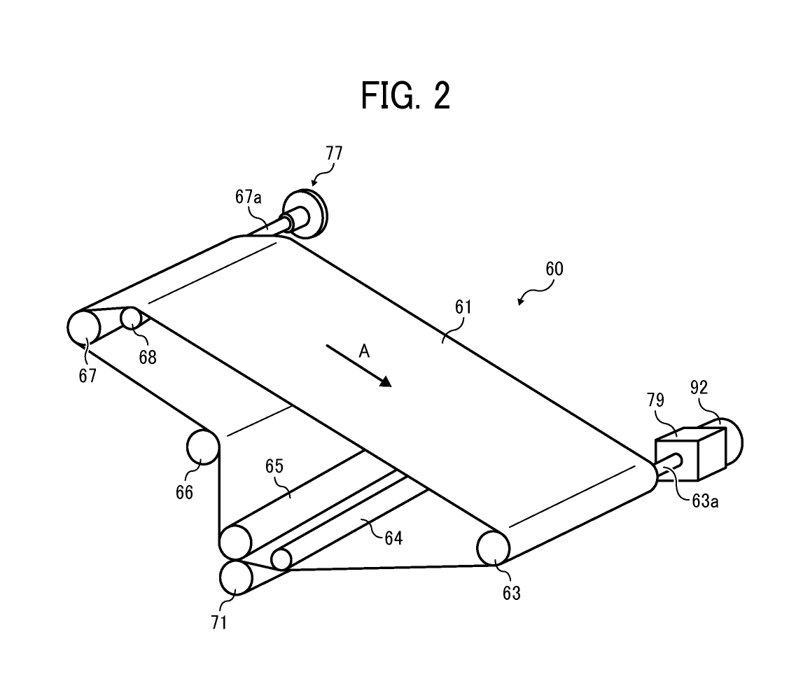

FIG. 1 is a schematic diagram illustrating a color printer as an example of an image forming apparatus using a tandem-type indirect transfer method according to an illustrative embodiment of the present disclosure. FIG. 2 is a perspective view schematically illustrating a transfer device employed in the image forming apparatus illustrated in FIG. 1.

As illustrated in FIG. 1, the image forming apparatus is a printer and includes four process units 2Y, 2M, 2C, and 2K (collectively referred to as process units 2) for forming toner images of yellow, magenta, cyan, and black, respectively. It is to be noted that the suffixes Y, M, C, and K denote colors yellow, magenta, cyan, and black, respectively. To simplify the description, these suffixes are omitted herein, unless otherwise specified.

The image forming apparatus also includes a paper delivery path 21, a pair of positioning rollers 37, a fixing device 43, and a transfer device 60, an optical writing unit, and so forth. The paper delivery path 21 includes a plurality of guide plates to deliver recording media sheets such as regular paper and gloss paper. The recording media sheets include, but are not limited to, regular paper, gloss paper, a resin sheet, a film, and a cloth.

The optical writing unit includes a laser diode, a polygon mirror, various lenses, and so forth. Based on image information provided by external devices such as a personal computer (PC), the optical writing unit drives and modulates the laser diode, and illuminates photoconductors 3Y, 3M, 3C, and 3K with laser light L corresponding to images for each color.

The process units 2Y, 2M, 2C, and 2K include drum-shaped photoconductors 3Y, 3M, 3C, and 3K, respectively, that bear a toner image of a respective color. The photoconductors 3Y, 3M, 3C, and 3K are rotated in a counterclockwise direction indicated by an arrow in FIG. 1 by a driving device.

The photoconductors 3Y, 3M, 3C, and 3K of the process units 2Y, 2M, 2C, and 2K are surrounded with respective charging rollers 16Y, 16M, 16C, and 16K, and developing devices 4Y, 4M, 4C, and 4K along a direction of rotation of the photoconductors 3Y, 3M, 3C, and 3K indicated by arrow Dl. Furthermore, primary transfer rollers 62Y, 62M, 62C, and 62K, drum cleaning devices 18Y, 18M, 18C, and 18K, and charge erasing lamps 20Y, 20M, 20C, and 20K are also disposed around the respective photoconductors 3Y, 3M, 3C, and 3K.

The optical writing unit scans surfaces of the rotating photoconductors 3Y, 3M, 3C, and 3K with laser light L in a main scanning direction at a position between the charging rollers 16Y, 16M, 16C, and 16K, and the developing devices 4Y, 4M, 4C, and 4K. The main scanning direction herein coincides with an axial direction of a rotary shaft of the photoconductors 3Y, 3M, 3C, and 3K.

Accordingly, the uniformly charged surfaces of the photoconductors 3Y, 3M, 3C, and 3K are exposed in accordance with image data for each color, thereby forming electrostatic latent images, one for each of the colors yellow, magenta, cyan, and black on the surface of the respective photoconductors 3Y, 3M, 3C, and 3K.

In the image forming apparatus of the present illustrative embodiment of the present disclosure, four process units 2Y, 2M, 2C, and 2K are arranged in tandem with a predetermined interval between each other above an intermediate transfer belt 61 along a direction of travel of the intermediate transfer belt 61 in a configuration known as a tandem type.

Each of the process units 2Y, 2M, 2C, and 2K is constituted of each of the respective photoconductors 3Y, 3M, 3C, and 3K, and the surrounding devices held by a common holder, except the primary transfer rollers 62Y, 62M, 62C, and 62K. With this configuration, each of the process units 2Y, 2M, 2C, and 2K is detachably mountable relative to the main body of the image forming apparatus.

The process units 2Y, 2M, 2C, and 2K all have the same configuration as all the others, differing only in the color of toner employed in the developing devices 4Y, 4M, 4C, and 4K.

For example, the process unit 2Y, as a representative example of the process units, includes the photoconductor 3Y, the charging roller 16Y, the developing device 4Y, the drum cleaning device 18Y, and so forth. The charging roller 16Y charges uniformly the surface of the photoconductor 3Y. The developing device 4Y develops an electrostatic latent image formed on the surface of the photoconductor 3Y with yellow toner. The drum cleaning device 18Y removes residual toner remaining after a transfer operation.

The charging rollers 16Y, 16M, 16C, and 16K charge outer circumferential surfaces of the photoconductors 3Y, 3M, 3C, and 3K, respectively, while the photoconductors 3Y, 3M, 3C, and 3K rotate in a direction of arrow in FIG. 1.

The photoconductors 3Y, 3M, 3C, and 3K are constituted of a conductive element tube made of, for example, aluminum. Organic photosensitive material is applied to the conductive element tube to form a photosensitive layer thereon. Alternatively, in some embodiments, a belt-type photoconductor can be used as a photoconductor.

The developing devices 4Y, 4M, 4C, and 4K contain a two-component developing agent including non-magnetic toner and magnetic carrier. The electrostatic latent images on the photoconductors 3Y, 3M, 3C, and 3K are developed with the two-component developing agent of respective color, thereby forming a toner image. Alternatively, in some embodiments, instead of using the two-component developer, a single component or one-component developing agent is used.

The toner images formed on the outer circumferential surfaces of the photoconductors 3Y, 3M, 3C, and 3K in the development process are transferred onto the surface of the intermediate transfer belt 61 one atop the other by the primary transfer rollers 62Y, 62M, 62C, and 62K pressingly contacting the intermediate transfer belt 61. Accordingly, a full-color, composite toner image is formed on the intermediate transfer belt 61.

Residual toner remaining on the photoconductors 3Y, 3M, 3C, and 3K after the toner images are transferred onto the intermediate transfer belt 61 is removed by the drum cleaning devices 18Y, 18M, 18C, and 18K.

Subsequently, the surfaces of the photoconductors 3Y, 3M, 3C, and 3K are irradiated by the charge erasing lamps 20Y, 20M, 20C, and 20K to eliminate static electricity remaining on the photoconductors 3Y, 3M, 3C, and 3K in preparation for the subsequent imaging process.

The transfer device 60 is disposed below the process units 2Y, 2M, 2C, and 2K.

The transfer device 60 includes the intermediate transfer belt 61 serving as an image bearer. The intermediate transfer belt 61 is formed into an endless loop and entrained about a plurality of rollers 63 through 68 as illustrated in FIG. 2. Rotation of a drive roller 63 causes the intermediate transfer belt 61 to travel in a direction of arrow A while the upper surface of the intermediate transfer belt 61 horizontally held between a drive roller 63 and a driven roller 68 contacts the photoconductors 3Y, 3M, 3C, and 3K. The intermediate transfer belt 61 is formed into a loop and entrained about the drive roller 63, at least one driven roller, and a secondary-transfer opposed roller 65 which is pressed by a secondary transfer roller 71 upon secondary transfer.

The primary transfer rollers 62Y, 62M, 62C, and 62K are disposed inside the loop formed by the intermediate transfer belt 61 to contact the photoconductors 3Y, 3M, 3C, and 3K via the intermediate transfer belt 61.

The primary transfer rollers 62Y, 62M, 62C, and 62K press the intermediate transfer belt 61 against the photoconductors 3Y, 3M, 3C, and 3K, thereby forming primary transfer nips for yellow, magenta, cyan, and black at which the photoconductors 3Y, 3M, 3C, and 3K and the intermediate transfer belt 61 contact.

A primary transfer bias is applied to the primary transfer rollers 62Y, 62M, 62C, and 62K by a power source, thereby generating a primary transfer electrical field that attracts toner on the photoconductors 3Y, 3M, 3C, and 3K towards the intermediate transfer belt 61.

The secondary-transfer opposed roller 65 is disposed substantially at the bottom center of the looped intermediate transfer belt 61 in a longitudinal direction thereof. A tension roller 66 is disposed outside the looped intermediate transfer belt 61, downstream from the secondary-transfer opposed roller 65 in the traveling direction of the intermediate transfer belt 61. The tension roller 66 applies tension to the intermediate transfer belt 61 from outside the looped intermediate transfer belt 61. The secondary-transfer opposed roller 65 applies tension to the intermediate transfer belt 61 from inside the looped intermediate transfer belt 61. In other words, the intermediate transfer belt 61 is tensioned such that the intermediate transfer belt 61 is bent in opposite directions by the secondary-transfer opposed roller 65 and the tension roller 66 as illustrated in FIG. 2.

The secondary transfer roller 71 is disposed outside the looped intermediate transfer belt 61, opposite to the secondary-transfer opposed roller 65 via the intermediate transfer belt 61. The secondary transfer roller 71 is pressed against the secondary-transfer opposed roller 65 via the intermediate transfer belt 61, thereby forming a secondary transfer nip between the secondary transfer roller 71 and the outer surface of the intermediate transfer belt 61. The secondary transfer nip serves as a secondary transfer portion.

The power source applies the secondary-transfer opposed roller 65 a secondary transfer bias having the same polarity as that of normally-charged toner on the intermediate transfer belt 61, and the secondary transfer roller 71 is electrically grounded. Accordingly, a secondary transfer electrical field is formed in the secondary transfer nip.

In FIG. 1, the pair of positioning rollers 37 is disposed on the right of the secondary transfer nip with the paper delivery path 21 interposed therebetween. A pair of thickness detectors 38 is disposed on the right of the pair of positioning rollers 37 with the paper delivery path 21 interposed therebetween to detect a thickness of a recording medium.

After the leading end of the recording medium fed from a paper feed unit is detected by the pair of thickness detectors 38, the leading end of the recording medium is interposed between the pair of positioning rollers 37 and is temporarily stopped. The recording medium is then delivered to the secondary transfer nip along the paper delivery path 21 in appropriate timing such that the recording medium is aligned with the composite toner image on the intermediate transfer belt 61.

Detection of the thickness of the recording medium by the pair of thickness detectors 38 and usage of the information on the thickness are described later. A sheet detector 39 to detect the recording medium being delivered on the paper delivery path 21 is disposed in the middle between the pair of positioning rollers 37 and the secondary transfer nip. A description of detection signals provided by the sheet detector 39 is described later in detail.

When the recording medium passes through the secondary transfer nip between the intermediate transfer belt 61 and the secondary transfer roller 71 in a direction of arrow B in FIG. 1, the composite toner image on the intermediate transfer belt 61 is transferred onto the recording medium by an electrostatic force of the secondary transfer electrical field and a nip pressure. Then, the composite toner image becomes a full-color toner image on the while recording medium.

A belt cleaning device 69 is disposed outside the looped intermediate transfer belt 61, opposite to the driven roller 67 via the intermediate transfer belt 61 and downstream from the secondary transfer nip in the traveling direction of the intermediate transfer belt 61. The belt cleaning device 69 contacts the intermediate transfer belt 61 to remove any toner remaining on the intermediate transfer belt 61 after the secondary transfer process.

The recording medium onto which the composite toner image is transferred in the secondary transfer nip separates from the intermediate transfer belt 61 and is delivered to the fixing device 43 in the direction of arrow B.

The fixing device 43 includes a pressing roller 43a and a fixing roller 43b. The fixing roller 43b includes a heat source inside thereof. While rotating, the pressing roller 43a pressingly contacts the fixing roller 43b, thereby forming a heated area called a fixing nip therebetween.

As the recording medium passes through the fixing nip in the fixing device 43, the composite toner image on the recording medium is pressed against the recording medium and heated, thereby fixing the composite toner image on the recording medium.

The secondary transfer roller 71 that contacts the intermediate transfer belt 61 to form the secondary transfer nip is formed of a metal cored bar with an outer circumferential surface covered with an elastic member such as rubber.

In the secondary transfer nip, the portion of the intermediate transfer belt 61 wound around the secondary-transfer opposed roller 65 sinks in the elastic surface of the secondary transfer roller 71. Accordingly, the width of the secondary transfer nip in a transport direction of the recording medium is relatively wide.

As illustrated in FIG. 2, a belt drive motor 92 is attached to a rotary shaft 63a of the drive roller 63 in the transfer device 60 via a decelerator 79, thereby moving the intermediate transfer belt 61. That is, power is transmitted from the belt drive motor 92 serving as a drive source to the drive roller 63, thereby rotating the drive roller 63.

A dynamic vibration absorber 77 is attached to a rotary shaft 67a of the driven roller 67 disposed on the opposite side of the drive roller 63 in the horizontal direction. The driven roller 67 is one of the support rollers around which the intermediate transfer belt 61 is entrained. A description of the dynamic vibration absorber 77 will be provided later.

A description is now provided of positions of the intermediate transfer belt 61, the secondary transfer roller 71, and the plurality of support rollers about which the intermediate transfer belt 61 is entrained. The intermediate transfer belt 61 is entrained about the drive roller 63, the secondary-transfer opposed roller 65, an entry roller 64, the tension roller 66, the driven rollers 67 and 68, and the primary transfer rollers 62Y, 62M, 62C, and 62K. The drive roller 63 is rotatably driven by the belt drive motor 92 via the decelerator 79. The secondary-transfer opposed roller 65 is pressed by the secondary transfer roller 71. The entry roller 64 is disposed upstream from the secondary-transfer opposed roller 65 in the traveling direction of the intermediate transfer belt 61.

The tension roller 66 is disposed downstream from the secondary-transfer opposed roller 65 to apply tension to the intermediate transfer belt 61 from outside the looped intermediate transfer belt 61. The driven rollers 67 and 68 are disposed downstream from the tension roller 66. The primary transfer rollers 62 are disposed opposite the respective photoconductors 3 via the intermediate transfer belt 61. As described above, the dynamic vibration absorber 77 is connected to the driven roller 67.

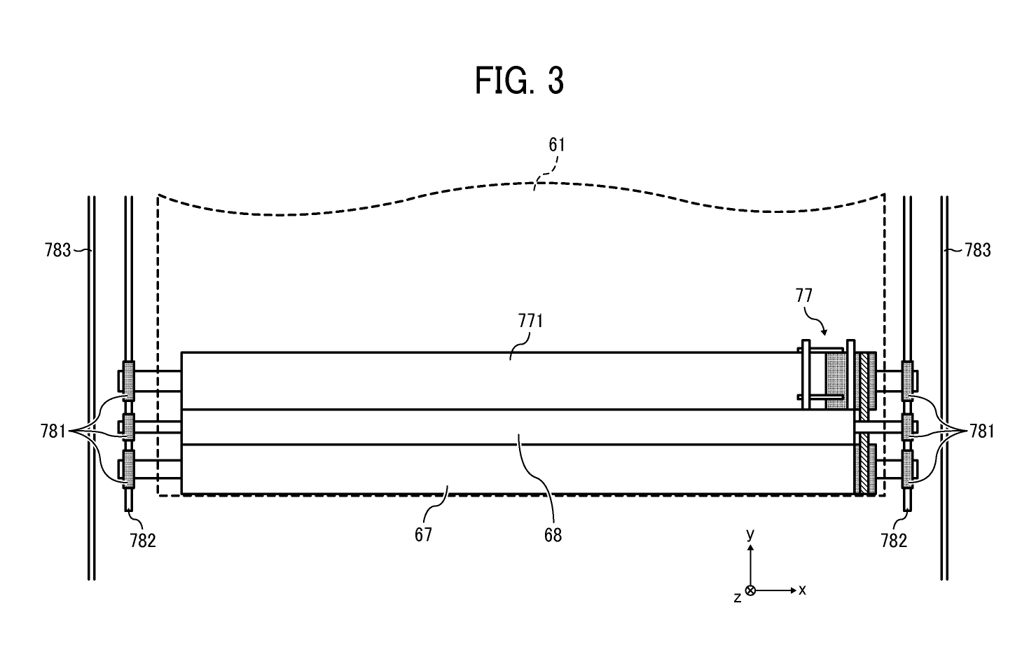

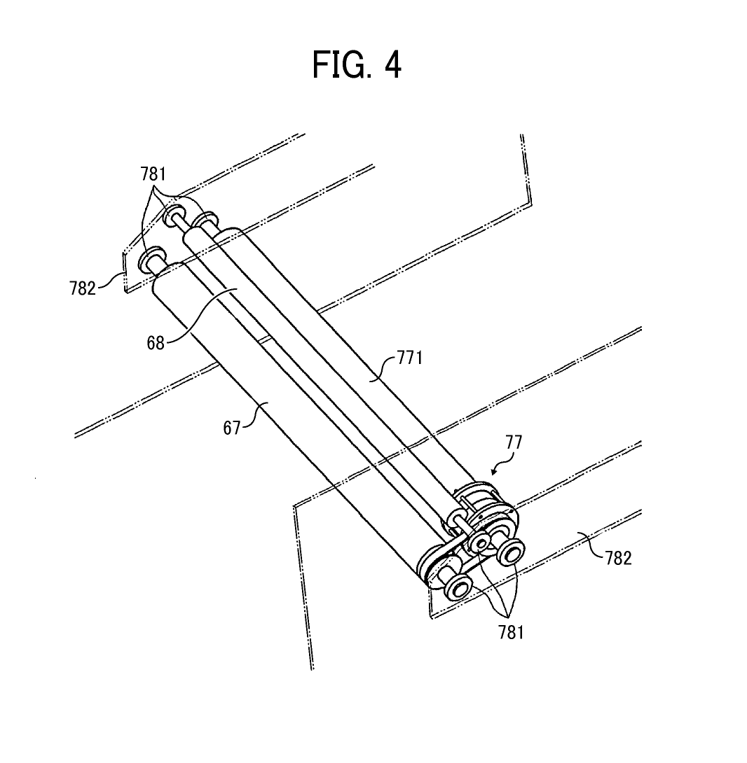

With reference to FIGS. 3 and 4, a description is now provided of the dynamic vibration absorber 77. FIG. 3 is a top view schematically illustrating the dynamic vibration absorber 77 according to an illustrative embodiment of the present disclosure. FIG. 4 is a perspective view of the dynamic vibration absorber 77. According to the present illustrative embodiment, the dynamic vibration absorber 77 is connected to the driven roller 67. According to the present illustrative embodiment, the dynamic vibration absorber 77 is connected to the driven roller 67. However, the roller to which the dynamic vibration absorber 77 is connected is not limited to the driven roller 67.

Alternatively, in some embodiments, the dynamic vibration absorber 77 is attached to one of the support rollers other than the driven roller 67. Preferably, however, the dynamic vibration absorber 77 is attached to a roller, for example the secondary-transfer opposed roller 65, around which the intermediate transfer belt 61 is wound at an angle of 90 degrees or more.

According to the present illustrative embodiment, the transfer device 60 is supported such that each of the support rollers, about which the intermediate transfer belt 61 is entrained, is supported by sub-lateral plates 782 at the unit side via shaft bearings 781. Furthermore, the transfer device 60 is supported by a front and a rear lateral plates (hereinafter collectively referred to as main-body lateral plates) 783 of a main body of the image forming apparatus.

The dynamic vibration absorber 77 is constituted mainly of three basic parts: an inertial body, a spring-functioning part, and a viscous-functioning part. The dynamic vibration absorber 77 is designed as follows. First, based on the size, weight, load torque, and so forth of the apparatus, the size of the inertial body and the moment of inertia are determined Next, a spring constant and a viscous damping coefficient of the dynamic vibration absorber 77 are determined based on physical parameters of a drive transmission system from the belt drive motor 92, the intermediate transfer belt 61, and the support rollers about which the intermediate transfer belt 61 is entrained.

The spring constant of the spring-functioning part has hardness of approximately 1/10 to 1/1000 times depending on the moment of inertia of an inertial body 771, as compared with the related-art configuration in which a flywheel is attached to a driven roller. The viscous damping coefficient has viscosity of approximately 10 to 1000 times. The specific example of material for the spring part includes, but is not limited to resin, rubber, a fine metal stick, and so forth, or a combination of these material.

The inertial body 771 is arranged in parallel with the support rollers such as the driven roller 67 inside the looped intermediate transfer belt 61, and has a columnar shape or a cylindrical shape. The inertial body 771 does not contact the intermediate transfer belt 61. The inertial body 771 includes a shaft with both ends thereof rotatably supported by the sub-lateral plates 782 via the shaft bearings 781. As described above, having the inertial body 771 inside the sub-lateral plates 782 can reduce a spatial distance between the main-body lateral plate 783 and the sub-lateral plate 782. With this configuration, the dynamic vibration absorber 77 can be disposed without increasing the distance between the main-body lateral plates.

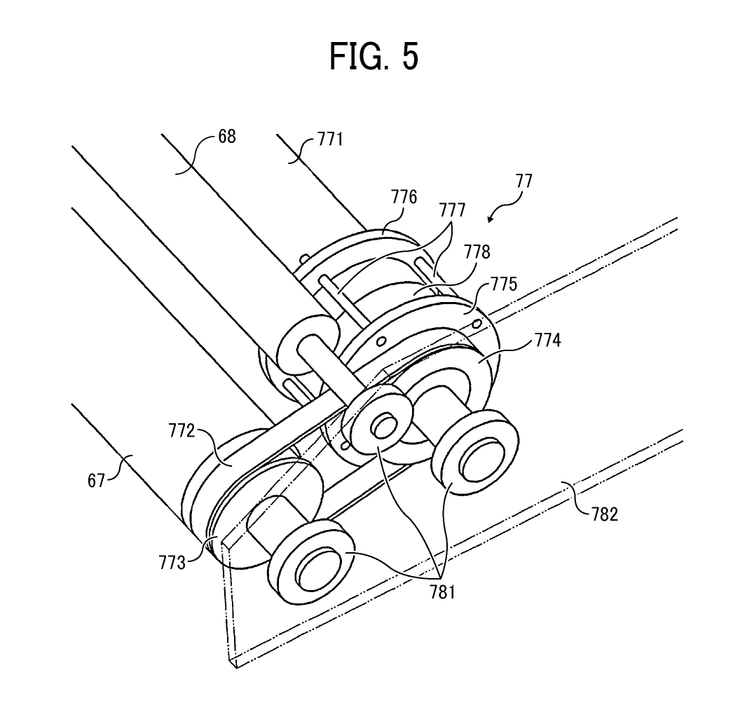

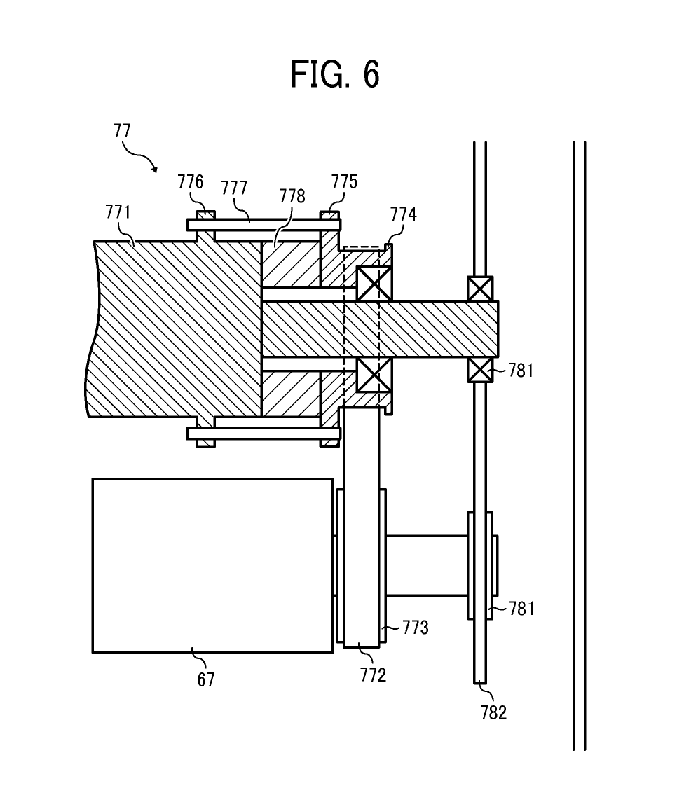

With reference to FIGS. 5 and 6, a description is provided of a rotation transmission device, the spring-functioning part, and the viscous-functioning part. FIGS. 5 and 6 are enlarged schematic diagrams illustrating the dynamic vibration absorber 77 according to an illustrative embodiment of the present disclosure. FIG. 5 is a partially enlarged perspective view schematically illustrating the dynamic vibration absorber 77. FIG. 6 is a cross-sectional view schematically illustrating the dynamic vibration absorber 77.

The driven roller 67 and the dynamic vibration absorber 77 are connected by a belt 772 which is backlash-less, thereby transmitting rotation. The belt 772 is formed of a flat belt or a timing belt. A pulley 773 is fixed to the shaft of the driven roller 67 and rotates together with the driven roller 67. The belt 772 is entrained about the pulley 773. A pulley 774 is disposed on one end of the shaft of the inertial body 771 via a shaft bearing 781 and is rotatable relative to the inertial body 771.

Next, a description is provided of the spring-functioning part. A pulley flange 775 is disposed at an end surface of the pulley 774 to support one end of torsion bars 777 serving as the spring-functioning part. The pulley flange 775 also serves as a belt tracker to prevent the belt 772 from drifting off center. The other end of the torsion bars 777 is supported by an inertial body flange 776 disposed on the peripheral surface of the inertial body 771. The number of torsion bars 777 depends on the spring constant of the dynamic vibration absorber 77. Preferably, however, the torsion bars 777 are evenly disposed. The end surface of the inertial body 771 and the pulley flange 775 support the torsion bars 777 without the inertial body flange 776.

Next, a description is provided of the viscous-functioning part. A viscoelastic rubber 778 illustrated in FIGS. 5 and 6 is formed of viscoelastic rubber formed into a cylindrical shape and is joined with the end surface of the inertial body 771 and with the end surface of the pulley flange 775 coaxially on the same shaft as the inertial body 771. Joining methods include, but are not limited to, using double-sided tape, adhesive agents, and baking.

With this configuration, rotation of the driven roller 67 is transmitted from the pulley 773 to the belt 772 and to the pulley 774. Then, rotation of the pulley 774 is transmitted to the inertial body 771 with the torsion bars 777 and the viscoelastic rubber 778 being parallel.

In some embodiments, the spring constant and viscosity of the dynamic vibration absorber 77 can be obtained by the viscoelastic rubber 778 alone. The spring constant can be obtained based on the material, hardness, and shape of the rubber, and incorporated into the design value. Viscosity can be adjusted by physical properties of compositions of the rubber. In this case, the torsion bars 777 are not necessary. In the configurations illustrated in FIGS. 3 through 6, the spring constant is adjusted by the hardness of the viscoelastic rubber 778, and the diameter and the length of the torsion bar 777, and is incorporated in the design value.

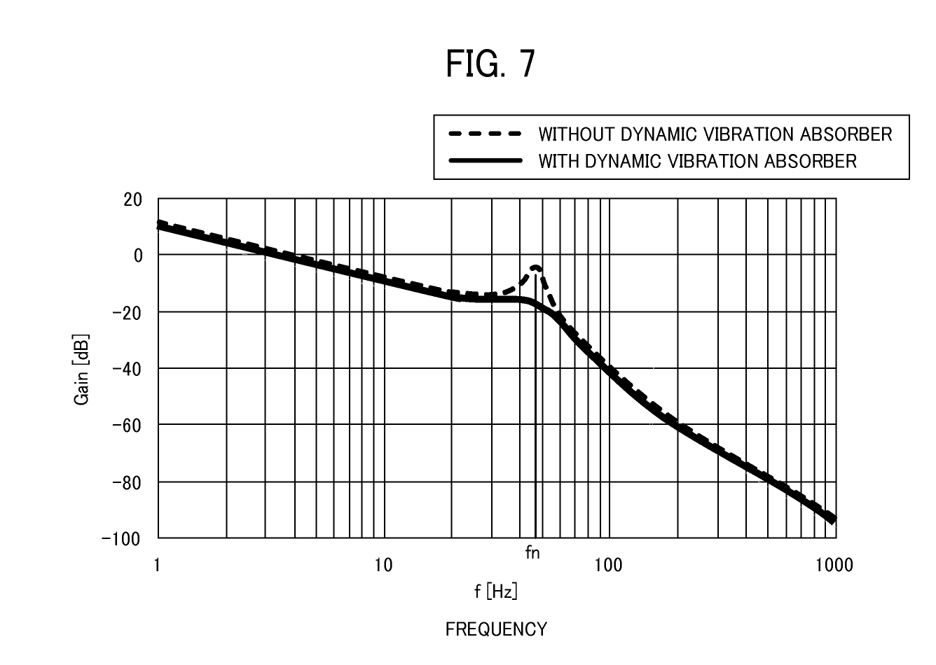

FIG. 7 is a graph showing measured frequency response characteristics from the drive transmission system from the belt drive motor 92 to the driven roller 67, as compared with the related-art configuration. A broken line in FIG. 7 represents normal frequency response characteristics without the dynamic vibration absorber 77 and shows a rise in the peak value of gain (dB) at the resonance point (fn) of the frequency. By contrast, a solid line in FIG. 7 represents frequency response characteristics when using the dynamic vibration absorber 77 according to the illustrative embodiment of the present disclosure and shows a smaller peak value of gain (dB) at the resonance point (fn).

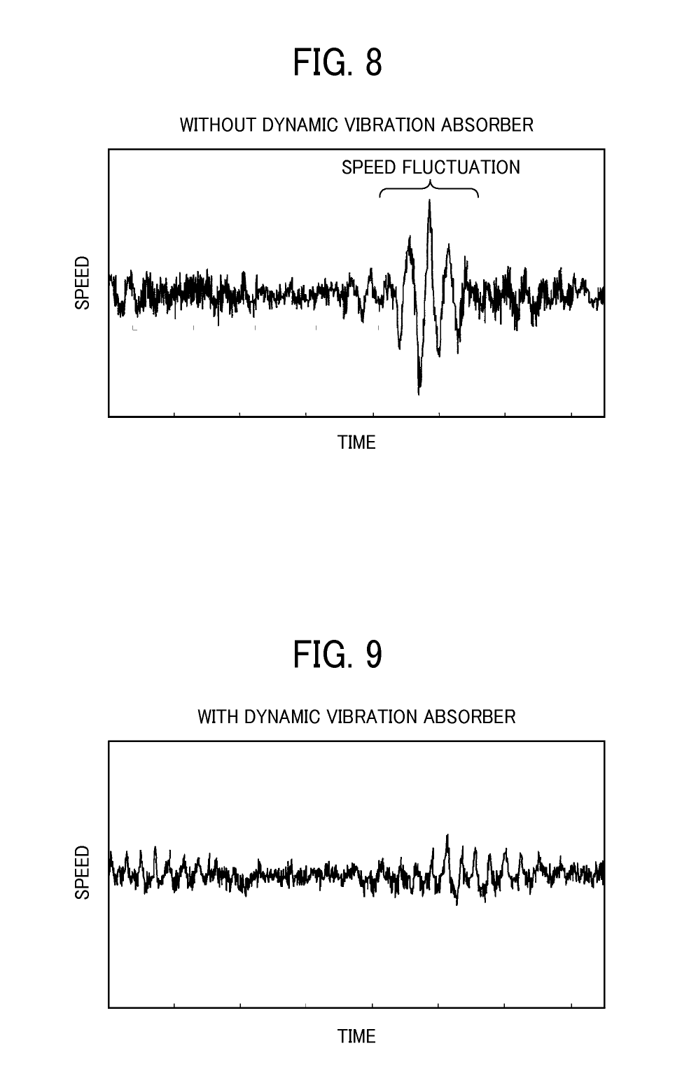

FIG. 8 is a waveform chart showing fluctuation of the traveling speed of the intermediate transfer belt 61 before and after the recording medium enters the secondary transfer nip in a case in which the dynamic vibration absorber 77 is not attached to the driven roller 67. As shown in FIG. 8, when the recording medium entered the secondary transfer nip or the secondary transfer position, the speed of the intermediate transfer belt changed significantly. The cycle of fluctuation coincides with the frequency at the resonance point shown in FIG. 7.

FIG. 9 is a waveform chart showing fluctuation of the traveling speed of the intermediate transfer belt 61 before and after the recording medium enters the secondary transfer nip in a case in which the dynamic vibration absorber 77 is attached to the driven roller 67. The dynamic vibration absorber 77 employed in the present illustrative embodiment is designed to have the frequency response characteristics having the gain with a smaller peak at the resonance point shown in FIG. 7. With this configuration, when the recording medium enters the secondary transfer nip, the shock jitter or fluctuation in the traveling speed of the intermediate transfer belt can be reduced.

With the dynamic vibration absorber 77, when the recording medium enters the secondary transfer nip, the shock jitter or fluctuation in the traveling speed of the intermediate transfer belt 61 is reduced, if not prevented entirely. Images of ever-higher quality are obtained. As compared with the related-art configuration using a flywheel, the dynamic vibration absorber 77 can be disposed inside the housing of the transfer device 60, thereby downsizing the image forming apparatus as a whole.

Furthermore, the dynamic vibration absorber 77 transmits fluctuation of rotation of the driven roller 67 to the inertial body 771 via the belt 772, thereby transmitting the rotation without backlash and can fully function as the dynamic vibration absorber.

The dynamic vibration absorber 77 includes the spring-functioning part and the viscoelastic part constituting a joint mechanism that connects the pulley 774 and the inertial body 771. This configuration allows the parts constituting the dynamic vibration absorber 77 to be connected within a small area in the loop formed by the belt 772, thereby achieving a saving of space.

Furthermore, according to the illustrative embodiment, in the dynamic vibration absorber 77 the pulley 774 and the inertial body 771 are connected by the viscoelastic rubber 778 so that a force that causes the pulley 774 to rotate can be reduced and the reduced force is transmitted to the inertial body 771. With this configuration, the viscoelastic rubber 778 absorbs movement caused by shock jitter that causes significant displacement of the intermediate transfer belt 61 within a short period of time.

Furthermore, the dynamic vibration absorber 77 employs the spring-functioning part constituted of the inertial body flange 776 and the pulley flange 775 connected by the torsion bars 777. With this configuration, the spring-functioning part can be disposed within a small area in the belt loop in the horizontal as well as vertical directions, thereby achieving a saving of space. Furthermore, with the combination of the viscoelastic rubber 778 connecting the end portion of the inertial body 771 and the end portion of the pulley 774, the viscous function can be formed inside the spring function, thereby providing the greater compactness of the dynamic vibration absorber 77.

According to the present disclosure, the shock jitter of the intermediate transfer belt is reduced when a recording medium enters the secondary transfer position, thereby preventing imaging failure with a reduced size and cost of the image forming apparatus.

According to an aspect of this disclosure, the present invention is employed in the image forming apparatus. The image forming apparatus includes, but is not limited to, an electrophotographic image forming apparatus, a copier, a printer, a facsimile machine, and a digital multi-functional system.

Furthermore, it is to be understood that elements and/or features of different illustrative embodiments may be combined with each other and/or substituted for each other within the scope of this disclosure and appended claims. In addition, the number of constituent elements, locations, shapes and so forth of the constituent elements are not limited to any of the structure for performing the methodology illustrated in the drawings.

Example embodiments being thus described, it will be obvious that the same may be varied in many ways. Such exemplary variations are not to be regarded as a departure from the scope of the present invention, and all such modifications as would be obvious to one skilled in the art are intended to be included within the scope of the following claims.

What is claimed is:

1. A transfer device, comprising:
at least one pair of lateral plates;
an intermediate transfer belt formed into an endless loop;
a plurality of rollers about which the intermediate transfer belt is entrained; and
a dynamic vibration absorber disposed on at least one of the plurality of rollers, including an inertial body disposed inside the endless loop of the intermediate transfer belt,
both ends of the inertial body in an axial direction of the inertial body being rotatably supported by the at least one pair of lateral plates via shaft bearings.

2. The transfer device according to claim 1, further comprising a belt to transmit rotation of the at least one of the plurality of rollers with the dynamic vibration absorber to the inertial body.

3. The transfer device according to claim 2, further comprising:
a pulley about which the belt is entrained to receive the rotation of the at least one of the plurality of rollers from the belt; and
a connector to connect the inertial body and the pulley.

4. The transfer device according to claim 3, wherein the connector includes a viscous-functioning part to connect the inertial body and the pulley.

5. The transfer device according to claim 3, wherein the connector includes a spring-functioning part.

6. The transfer device according to claim 5, wherein the spring-functioning part is a torsion bar, the inertial body includes an inertial-body flange, and the pulley includes a pulley flange,
the inertial-body flange and the pulley flange are connected by the torsion bar.

7. An image forming apparatus, comprising a transfer device according to claim 1.
